(19) United States
(12) Patent Application Publication
(10) Pub. No.: US 2015/0088737 A1
(43) Pub. Date: Mar. 26, 2015

(54) METHOD FOR ELECTRICALLY PERSONALIZING A PAYMENT CHIP AND A PAYMENT CHIP

(71) Applicant: MasterCard Asia Pacific Pte. Ltd., Singapore (SG)

(72) Inventor: William Chi Yuen Chan, Hong Kong (HK)

(21) Appl. No.: 14/492,397

(22) Filed: Sep. 22, 2014

(30) Foreign Application Priority Data
Sep. 24, 2013 (SG) 201307196-4

(51) Int. Cl. G06Q 20/34; G06K 19/07

(52) U.S. Cl. CPC G06Q 20/341; G06K 19/0723
USPC 705/41; 235/492

(57) ABSTRACT

Various embodiments provide a method for electrically personalizing a payment chip, the method comprising a. storing software onto the payment chip, the software comprising one or more parameters, the one or more parameters being configurable to define functions of the payment chip; and b. setting at least one parameter to a default value to configure at least one function of the payment chip to electrically personalize the payment chip, wherein step a. is performed by at least one entity and step b. is performed by the same at least one entity.

### CROSS-REFERENCE TO RELATED APPLICATION

This application is a U.S. National Stage filing under 35 U.S.C. §119, based on and claiming benefit of and priority to SG Patent Application No. 201307196-4 filed Sep. 24, 2013.

### TECHNICAL FIELD

Various embodiments relate to a method for electrically personalizing a payment chip and a payment chip.

### BACKGROUND

It is known to provide payment cards having payment chips to facilitate the performing of payments electronically. A customer may have one or more payment cards, such as, for example, one or more credit or debit cards. The customer may use one of the payment cards in conjunction with a merchant's device (e.g. an electronic point of sale) to perform a payment with the merchant. For example, the customer may wish to purchase goods or services from the merchant, and so the customer may use the payment card to transfer funds into the merchant's account in exchange for receiving the goods or services from the merchant. The payment chip may be fitted with a near-field-communications (NFC) capability to enable contactless payments to be performed between the payment chip and a merchant's device.

It can be a challenge for financial institutions (e.g., banks) to configure payment chips for use. Before a payment chip can be used, it may be necessary to personalize (e.g. configure) the payment chip such that it relates to a specific bank account administered by the financial institution. After the payment chip is personalized, the payment chip may be used to make payments from the specific bank account. The financial institution may not have sufficient technical expertise to correctly personalize the payment chip for use. It may be impossible to use the payment chip to perform a transaction if it is not correctly personalized.

### SUMMARY

Various embodiments provide a method for electrically personalizing a payment chip, the method comprising a. storing software onto the payment chip, the software comprising one or more parameters, the one or more parameters being configurable to define functions of the payment chip; and b. setting at least one parameter to a default value to configure at least one function of the payment chip to electrically personalize the payment chip, wherein step a. is performed by at least one entity and step b. is performed by the same at least one entity.

In an embodiment, the method further comprises storing data onto the payment chip by the at least one entity, the data being used by the payment chip to perform the configured at least one function.

In an embodiment, the data comprises at least one of the following: application data, issuer data, customer data, an application encryption key, an issuer related encryption key, an encryption certificate.

In an embodiment, the at least one function configures the payment chip to be able to communicate in accordance with the Europay, MasterCard and Visa (EMV) standard.

In an embodiment, the at least one function configures the payment chip to be able to make a payment in accordance with the EMV standard.

In an embodiment, the at least one function configures the payment chip to be able to make the payment from an account associated with a specific issuer.

In an embodiment, the at least one function configures the payment chip to be able to make the payment from an account associated with a specific customer.

In an embodiment, the software comprises an operating system.

In an embodiment, the software comprises at least one application program comprising the one or more parameters.

In an embodiment, the method further comprises, before step a., manufacturing the payment chip.

In an embodiment, the method further comprises attaching the payment chip to a carrier by the at least one entity.

In an embodiment, the carrier is at least one of the following: a plastic card, a computing device.

In an embodiment, the method further comprises c. setting the at least one parameter from the default value to a custom value to re-configure the at least one function of the payment chip.

In an embodiment, step c. is performed by the at least one entity.

In an embodiment, the at least one entity is a manufacturer of the payment chip.

Various embodiments provide a payment chip having thereon software comprising one or more parameters, the one or more parameters being configurable to define functions of the payment chip, wherein at least one parameter is set to a default value to configure at least one function of the payment chip.

In an embodiment, the payment chip having stored thereon data and the payment chip is capable in use of using the data to perform the configured at least one function.

### BRIEF DESCRIPTION OF THE DRAWINGS

Embodiments of the invention will now be better understood and readily apparent to one of ordinary skill in the art from the following written description, by way of example only, and in conjunction with the drawings, wherein like reference signs relate to like components, in which:

FIG. 1 shows a block diagram of a payment chip incorporated in a carrier in accordance with an embodiment;

FIG. 2 shows a flowchart of a method for electrically personalizing a payment chip in accordance with an embodiment;

FIG. 3 shows a flowchart of a method for electrically personalizing a payment chip in accordance with another embodiment.

FIG. 4 shows a computer system for performing a method for electrically personalizing a payment chip in accordance with an embodiment;

FIGS. 5 and 6(a) to 6(c) show tables of parameters of the EMV standard;

FIGS. 7(a) to 7(c) show tables of parameters of the PSE standard; and

FIG. 8 shows a table of additional parameters.

### DETAILED DESCRIPTION

A payment chip may be microchip, integrated circuit, semiconductor chip or the like. The payment chip may include a set of electronic circuits on one small plate of semiconductor material, normally silicon. In use, the payment chip may facilitate various financial operations, such as, for example, making a payment or receiving a payment. The payment may relate to a particular account administered by a particular issuer (e.g. financial institution or bank) and held by a particular customer (e.g. a person or a company). Accordingly, the customer may use the payment chip to perform financial operations relating to their account. It is to be understood that in order to perform or receive payments the payment card may have to communicate with an external device, such as, for example, a merchant's electronic point of sale.

It is to be understood that an issuer may be an entity (e.g. a company or organization) which issues (i.e. gives out, distributes, delivers) payment chips to payment chip users. The payment chip may, of course, be fixed to a payment card. Additionally, a customer may be an entity (e.g. a person or company) which uses the payment chip, for example, to make or receive a payment into an account, such as, a bank account. A manufacturer may be an entity (e.g. a person or company) which manufactures payment chips and/or payment cards and/or other carriers to which the payment chips may be fixed. Examples of such carriers include computing devices (e.g. mobile phones, tablet computers) or computing device parts.

In an embodiment, an entity is a person or a group of persons. In an embodiment, an entity is a business, a company, a corporation or an organization. An entity may have a unique and separate existence from all other entities. The entity may include a group of separate or joined companies which co-operate to achieve a similar business goal. The entity may be arranged in a hierarchy, for example, the entity may include a company (e.g. a holding company) and one or more subsidiary companies which are owned, partially owned or associated with the company. In an embodiment, the manufacturer (e.g. a fabrication company) may produce payment chips (a first business goal), for example, by fabricating or assembling the payment chips. In an embodiment, the issuer (e.g. a bank or financial institution) may issue payment chips (a second business goal), for example, by delivering, giving or providing them to a customer. In an embodiment, the customer may use the payment chips (a third business goal), for example, to make payments in exchange for goods and/or services.

The payment chip may be a radio-frequency identification (RFID) chip or a near-field-communications (NFC) chip. Accordingly, the payment chip may be operable to communicate with an external device via NFC, such as, via the MasterCard™ PayPass™ protocol or via another contactless payment protocol as would be known to a person skilled in the art.

A payment chip may be attached onto a portion of material, such as, metal, card or plastic (e.g. a plastic card). Plastic cards of this form may be referred to as credit cards, debit cards, payment cards and the like. Such cards may be used to purchase goods and/or services from a merchant, such as, for example, a shop or a business.

Personalization may be part of the manufacturing process relating to the preparation of a payment chip and/or a payment card. Personalization transforms a generic chip or card into an individually specific chip or card that can be used in one or more applications. In an example, personalizing a chip or card ensures that it corresponds to a particular issuer and/or customer and/or function. There are different types of personalization including: magnetic personalization, graphical personalization and electrical personalization. Electrical personalization may include storing software and data (e.g. customer data and/or issuer data) onto the payment chip, then setting parameters of the software to configure functions of the payment chip so that it may be used to perform or receive payments.

It is to be understood that the payment chip and payment card may be manufactured by the same or separate entities. In any case, the payment chip and the payment card will be subject to a manufacturing process during which the chip and card are fabricated. The card manufacturer may attach the payment chip onto a plastic card after receiving or manufacturing the payment chip.

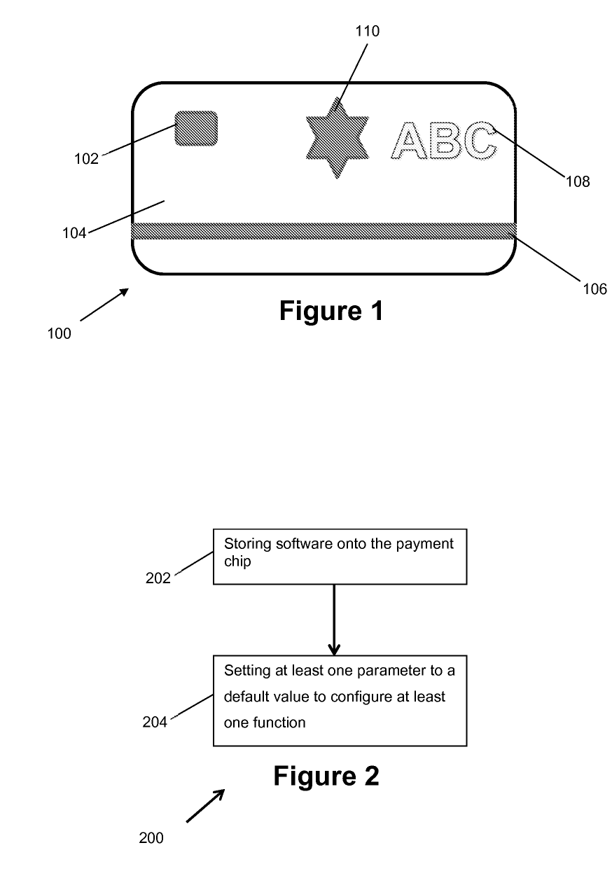

FIG. 1 shows a payment card 100 in accordance with an embodiment. The payment card 100 may include a payment chip 102 fixed to a carrier 104. In an embodiment, the carrier 104 is a piece or portion of plastic. The payment card 100 also comprises a magnetic strip 106 and graphics including, for example, text 108 and an image 110. In another embodiment, the carrier 104 may be a computing device, such as, for example, a mobile telephone, a cellphone, a personal digital assistant (PDA), a tablet computer, a laptop computer or the like.

The payment chip 102 includes software that is stored or installed onto it. The software may define the functionality (i.e. some or all functions) of the payment chip 102. The software may include an operating system and one or more application programs. The software includes one or more parameters (i.e. variables or attributes) which are configurable to define functions of the payment chip. The parameters may be part of the one or more application programs and/or the operating system. At least one of the parameters is configurable to be set to a default value so as to configure at least one function of the payment chip 102. This setting of one or more parameters to a default value at least partly electrically personalizes the payment chip 102. In an embodiment, the at least one configured function of the payment chip 102 may enable the payment chip to make a payment.

As mentioned above, personalization of the payment card 100 may include one or more different types of personalization, each of which may be done in different stages. Graphical personalization of the payment card 100 may include printing or embossing text 108 or pictures 110 on a surface of the carrier 104. In one embodiment, the text 108 or pictures 110 could be associated with the issuer which holds an account to which the payment chip 102 relates. In another embodiment, the text 108 or pictures 110 could be associated with a manufacturer of the payment card 100. Magnetic personalization of the payment card 100 may include encoding the magnetic strip 106 with data. Electrical personalization of the payment card 100 may include storing software and/or data onto the payment chip 102. The data and/or software applied during the magnetic and electrical personalization steps may relate to the issuer and/or customer corresponding to the payment card 100.

In an example, a manufacturer may have fabricated a generic payment card 100 without text or images, but with a blank magnetic strip 106 and blank payment chip 102. As part of the stages of manufacture, the manufacturer may perform graphical personalization on the generic payment card 100 by printing text 108 and images 110 corresponding to the bank (i.e. issuer) which holds the account of the customer. Additionally, the manufacturer may perform at least a portion of the magnetic personalization by encoding at least some generic data, issuer specific data and/or customer specific data on the magnetic strip 106. Additionally, the manufacturer may perform at least a portion of the electrical personalization by storing at least some generic data, issuer specific data and/or customer specific data onto the payment chip 102.

It is to be understood that the issuer may also perform at least some personalization. Specifically, the issuer may complete the magnetic personalization by encoding at least some generic data, issuer specific data and/or customer specific data on the magnetic strip 106. Additionally, the issuer may complete the electrical personalization by storing at least some generic data, issuer specific data and/or customer specific data onto the payment chip 102. For example, in the case of payment cards, where the manufacturer completes all personalization, the payment card may be a prepaid payment card. By way of example, the manufacturer stores or installs a software or software package and sets at least one parameter to a default value to configure at least one function of the payment chip so as to produce the prepaid payment card. On the other hand, where the manufacturer performs some but not all personalization and the issuer completes the personalization by changing a default value to a customized value, the payment card may be specific to a particular issuer and customer (i.e. a bespoke payment card).

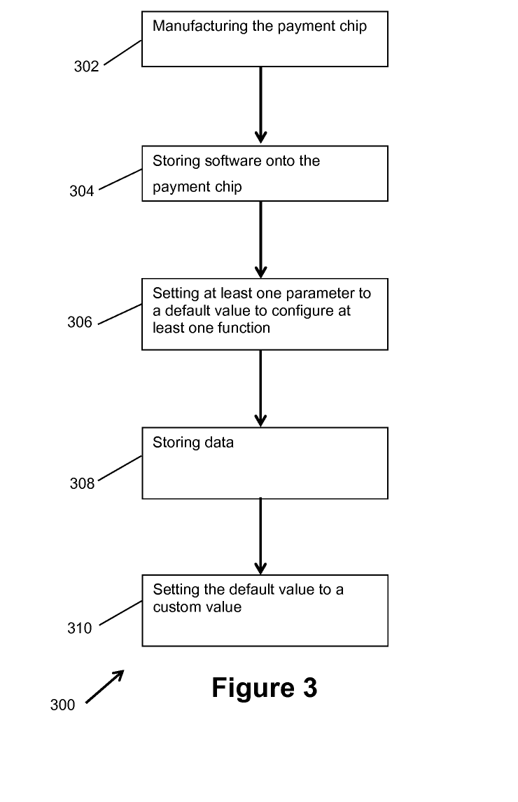

FIG. 2 shows a flowchart that illustrates a method 200 for electrically personalizing a payment chip in accordance with an embodiment. This method aims to provide an effective way to at least partly electrically personalize a payment chip. In an embodiment, each step of the method 200 is carried out by at same entity or entities. In an embodiment, each step of the method 200 is carried out by a manufacturer of a payment chip or payment card, rather than an issuer. In an embodiment, the manufacturer may be both the payment card and payment chip manufacturer.

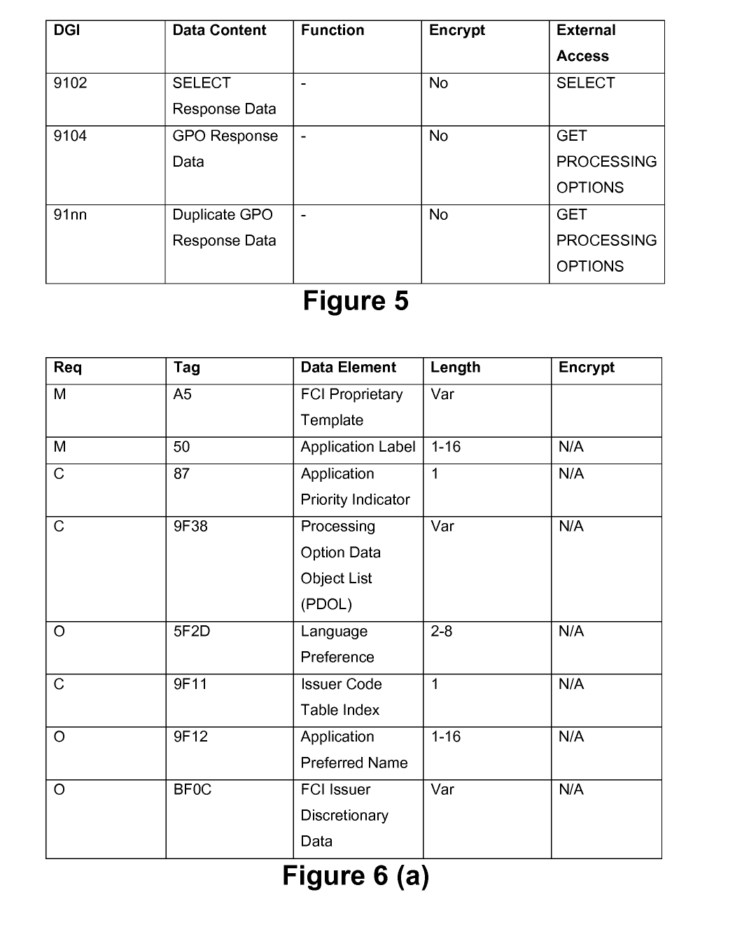

It is to be understood that a computer system may be used to implement the method 200. In an embodiment, the computer system may be used to prepare the software before it is stored or installed onto the payment chip, for example, as part of a data preparation process. In another embodiment, the computer system may be used to prepare the default values before they are set on the payment chip, for example, as part of the same or a separate data preparation process. The computer system may include a personalization device which is capable of electrically interfacing with the payment chip in order to communicate with the chip, for example, to transfer data to/from the chip. An exemplary computer system will be described later with respect to FIG. 4.

In 202, software or a software package is stored or installed onto a payment chip. The software includes one or more parameters. The one or more parameters are configurable to define functions of the payment chip. The payment chip may be the payment chip 102 of FIG. 1 which is part of the payment card 100. In an embodiment, the software or software package is stored or installed by at least one entity. In an embodiment, the at least one entity is the manufacturer.

In an embodiment, the software could include any general computer program. In an embodiment, the software could include a Europay, Mastercard and Visa (EMV) application program that is adapted to perform one or more functions in accordance with the EMV standard, for example, as defined in the EMV Card Personalization Specification Version 1.1 Jul. 2007. EMV is a global standard for inter-operation of payment cards that are capable of communicating with point of sale terminals and automated teller machines. The EMV standard may be used to authenticate credit and debit card transactions or payments.

In 204, at least one parameter of the software stored on the payment chip is set to a default value. The act of setting configures at least one function of the payment chip. The act of configuring at least partly electrically personalizes the payment chip. This process of setting parameters to default values to configure functions of the payment chip may thought of as part of a data preparation process. In an embodiment, the entity or entities which perform operation 202 also perform operation 204. In an embodiment, that entity or entities is/are a manufacturer of the payment chip.

In an embodiment, one parameter (e.g. P1) is set to a default value (D1) so as to configure one function (F1) of the payment chip. This parameter may be the only parameter in the software or may be one of a plurality of different parameters in the software.

In an embodiment, multiple parameters (e.g. P1 and P2) may be set to a default value so as to configure one function (e.g. F1) of the payment chip. Additionally or alternatively, multiple parameters (e.g. P1 and P2) may each be set to a default value so as to configure multiple functions (e.g. F1 and F2) of the payment chip. Additionally or alternatively, one parameter (e.g. P1) may be set to a default value so as to configure multiple functions (e.g. F1 and F2) of the payment chip. In an embodiment, the default value (e.g. D1) for one parameter (e.g. P1) may be different to the default value (e.g. D2) for another parameter (e.g. P2). In an embodiment, the default value may correspond to the parameter, such that each parameter has a default value which corresponds to that specific parameter. Also, multiple different parameters (e.g. P1 and P2) may share the same default value (e.g. D1).

In an embodiment, a function of the payment chip which is configured by the setting of parameters to default values enables the payment chip to communicate (i.e. transmit and/or receive data) in accordance with EMV standard. In an embodiment, a function of the payment chip which is configured by the setting of parameters to default values enables the payment chip to make and/or receive a payment in accordance with the EMV standard.

In an embodiment, a function of the payment chip which is configured by the setting of parameters to default values enables the payment chip to communicate (i.e. transmit and/or receive data) in accordance with Payment System Environment (PSE) standard. In an embodiment, a function of the payment chip which is configured by the setting of parameters to default values enables the payment chip to make and/or receive a payment in accordance with the PSE standard.

In an embodiment, a function of the payment chip which is configured by the setting of parameters to default values enables the payment chip to make a payment from an account (e.g. a bank account) associated with a specific issuer (e.g. financial institution or bank) in accordance with the EMV and/or PSE standard. In an embodiment, a function of the payment chip which is configured by the setting of parameters to default values enables the payment chip to make a payment from an account (e.g. a bank account) associated with a specific customer (e.g. person or company) in accordance with the EMV and/or PSE standard.

The payment chip is at least partly electrically personalized after at least one parameter is set to a default value, as described above. Accordingly, the payment chip may be a partly configured payment chip (e.g. for use with a bespoke payment card), such that some but not all payment chip functions are ready for use. The rest of the required functions may be configured by another entity which is different from the entity that performs operation 202, for example, an issuer. Alternatively, the payment chip may be a fully configured payment chip (e.g. for use with a prepaid payment card), such that all payment chip functions are ready for use. In this embodiment, all required functions may be configured by the same entity or entities, such as, a manufacturer. The personalized payment chip may then be provided to an issuer on its own or attached to a carrier or card (as shown in FIG. 1).

In an embodiment, when the payment chip is provided fully configured, the issuer may simply package the chip for sale. For example, the chip may be provided by the manufacturer to the issuer as part of a payment card which is fully personalized graphically, magnetically and electrically. Therefore, the issuer may simply offer the payment card for sale. Alternatively, when the payment chip is provided being only partly configured, the issuer may complete the configuration process to complete electrical personalization. For example, the manufacturer may store or install the software and set one or more parameters to default values, but the issuer may also set one or more parameters to default values to configure one or more functions of the payment chip. Additionally or alternatively, the issuer may set one or more parameters from default values to custom values to configure or reconfigure one or more functions of the payment chip. This may be done after the manufacturer stores or installs the software and sets one or more parameters to default values.

It is to be understood that a default value may be a generic value which configures a function for generic operation, such as, operation in accordance with a standard procedure used by a group of different parties. On the other hand, a custom value may be a specific value which configures a function for specific operation, such as, operation in accordance with a specific procedure which is implemented by only one or a few parties. The default value may be suitable for use by most issuers and/or issuers without advanced technical expertise. On the other hand, the custom value may be suitable for use by only a small number of issuers and/or issuers with advanced technical expertise. The issuer may also perform at least some graphical and/or magnetic personalization.

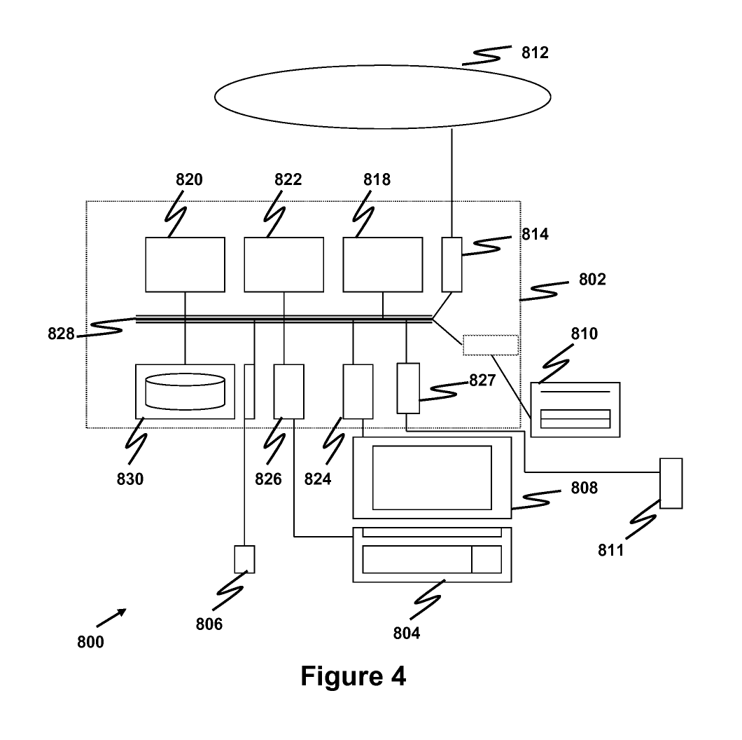

FIG. 3 is a flowchart of a method 300 for electrically personalizing a payment chip in accordance with an embodiment. This method aims to provide an effective way to at least partly electrically personalize a payment chip. In an embodiment, the method 300 is at least partly carried out by a manufacturer of a payment chip or payment card. By way of example, the manufacturer performs at least operations 302-308. Operation 310 may be carried out by an issuer of a payment chip or payment card.

As mentioned above, a computer system may be used to implement the method 300. The computer system may include a personalization device which is capable of electrically interfacing with the payment chip in order to communicate with the chip, for example, to transfer data to/from the chip. The computer system may be used to prepare the software before it is stored or installed onto the payment chip, for example, as part of a data preparation process. The computer system may be used to prepare the default values before they are set on the payment chip, for example, as part of a data preparation process. In an embodiment, at least one entity implements the computer system to prepare the software and default values. The computer system may be used to prepare the custom values before they are set on the payment chip, for example, as part of the same or a separate data preparation process. In an embodiment, the entity that implements the computer system to prepare the custom values may be different from the at least one entity. The computer system will be described later in more detail with respect to FIG. 4.

In 302, the payment chip is created or fabricated by a manufacturer. In an embodiment, the payment chip may be formed from a semiconductor wafer. The wafer may be made of silicon. The wafer may be subject to various pre-fabrication processes which prepare the wafer to be used to create one or more semiconductor chips. For example, the wafer could be polished to remove surface scratches and impurities. The wafer may be coated to improve one or more material properties. After pre-fabrication, the wafer may be formed into one or more semiconductor chips, for example, by cutting or slicing. The result of 302 is a blank semiconductor chip which can be used as a payment chip. In an embodiment, the payment chip is attached to a carrier, such as, a plastic card or a mobile computing device.

Operations 304 and 306 may be analogous to operations 202 and 204 of FIG. 2. Accordingly, software or a software package is stored or installed onto the blank payment chip manufactured in 302. The software includes one or more parameters. The one or more parameters are configurable to define functions of the payment chip. At least one parameter of the software stored on the payment chip is then set to a default value. The act of setting configures at least one function of the payment chip. The act of configuring at least partly electrically personalizes the payment chip.

In an embodiment, 304 and 306 are each performed by the same at least one entity. In an embodiment, the at least one entity is a manufacturer, i.e. a manufacturer of the payment chip or payment card. In an embodiment, 304 and 306 are part of a data preparation process performed by the manufacturer. In an embodiment, after 304 and 306, the payment chip is provided by the at least one entity to another entity, for example, the manufacturer to an issuer (e.g. a bank). In an embodiment, the payment chip may be attached to a carrier prior to being provided to the issuer. In another embodiment, the payment chip may be attached to a carrier by the issuer.

In 308, data may be stored onto the payment chip. The data may be used by the payment chip to perform a function configured by 304 and 306. In an embodiment, the data includes: generic data, data relating to an application program of the software stored on the payment chip (i.e. application data), data relating to an issuer to which the payment chip relates (i.e. issuer data), and/or data relating to a customer to which the payment chip relates (i.e. customer data). In an embodiment, the application data includes an application encryption key. In an embodiment, the issuer data includes an issuer related encryption key. In an embodiment, the stored data includes an encryption certificate.

In an embodiment, 308 may be performed by either the manufacturer or the issuer. In an embodiment, 308 is performed by both the issuer and manufacturer. In an embodiment, 308 is part of a data preparation process performed by the manufacturer and/or the issuer.

In 310, a default value set during 306 may be reset to a custom value. This operation may be performed by the manufacturer after the manufacturer sets the default value. For example, the manufacturing process may be performed in multiple phases. In one phase the manufacturer may set a given parameter to a default value which configures a payment chip function for use with a majority of issuers and/or customers. However, in a later phase, the payment chip may have been designated for use with a specific issuer who may be known to prefer a value which is different from the default value, i.e. a custom value. In this case, the default value may be changed from the default value to the custom value in order to reconfigure the function. In an alternative embodiment, the operation of 310 may be performed by the issuer after the at least partly configured payment chip is passed to from the manufacturer to the issuer. Accordingly, the manufacturer may set the default value to configure a function and the issuer may set the custom value to re-configure or customize the same function.

As mentioned above, the process of loading or storing software and data onto a payment chip may be performed as part of a data preparation process. In an embodiment, the data preparation process may be performed by a computer system. The computer system may include a personalization device for interfacing with a payment chip to transfer software and data to/from the payment chip. The manufacturer and the issuer may perform separate data preparation processes or may perform different parts of the same data preparation process. Additionally, the manufacturer and the issuer may have separate computer systems or may both use the same computer system.

In an embodiment, data preparation is the process that creates the data that is to be stored on a payment chip during card personalization. Some of the data created may be the same across all chips in a batch; other data may vary by chip. Some data, such as authentication keys, may be secret and may need to be encrypted at all times during the personalization process. In an embodiment, data preparation may be a single process or it may require interaction between multiple systems.

In an embodiment, the output of the data preparation process may be a file of personalization data, which is passed to a personalization device. The data preparation system may be configured in use to protect the completed personalization data file for integrity and authenticity.

In an embodiment, the personalization device may be a terminal that acts to control how personalization data is selected and then sent to the payment chip application program. The format of the personalization data may depend on the payment chip application program to which it is to be sent during personalization. The personalization device may have access to a security module to establish and operate a secure channel between the personalization device, on the one hand, and the application program on the payment chip, on the other.

In an embodiment, the personalization device may send a series of personalization commands to the payment chip. The payment chip application program may receive the personalization data from the personalization device and store it in its assigned location, for use when the EMV card application becomes operational, for example, when making a payment.

FIG. 4 shows an exemplary computer system 800 for use in performing the abovementioned operations, for example, as part of a data preparation process. In an embodiment, the computer system performs operations 202 and 204 of FIG. 2 and operations 304 to 310 of FIG. 3.

The computer system 800 includes a computer module 802, input modules such as a keyboard 804 and mouse 806 and a plurality of output devices such as a display 808, printer 810 and a personalization device 811.

The computer module 802 is connected to a computer network 812 via a suitable transceiver device 814, to enable access to, for example, the Internet or other network systems, such as, a Local Area Network (LAN) or a Wide Area Network (WAN).

The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, interface 826 to the keyboard 804 and I/O interface 827 to the personalization device 811.

The components of the computer module 802 typically communicate via an interconnected bus 828 and in a manner known to the person skilled in the relevant art.

The computer system 800 may function in accordance with software stored on the RAM 820 and/or the ROM 822. The software may include an operating system and one or more application programs. An application program may be supplied to the user of the computer system 800 encoded on a data storage medium, such as, a CD-ROM or flash memory carrier and read utilizing a corresponding data storage medium drive of a data storage device 830. The application program may be read and controlled in its execution by the processor 818. Intermediate storage of program data may be accomplished using RAM 820.

The personalization device 811 may be configured in use to communicate with a payment chip. For example, the personalization device 811 may be fitted with a socket into which the payment chip maybe plugged. The physical connection between the personalization device and the payment chip may also provide an electrical connection such that data can be exchanged between the personalization device 811 and the payment chip. In this manner, the personalization device 811 may be controlled by the computer system 800 to deliver software and/or data to/from the payment chip.

It is to be understood that the computer system 800 provides a non-limiting example of a suitable computer system. In some embodiments, one or more elements may be combined together into the same element. In some embodiments, one or more elements may be absent or duplicated. Additional elements may be present in some embodiments.

According to some of the above described embodiments, software including parameters is loaded onto a payment chip. Then, one or more of the parameters are set to default values to configure at least one function of the payment chip. The specific parameters set and the specific default values used may be specific to the application, the function, the issuer, the manufacturer and/or the customer.

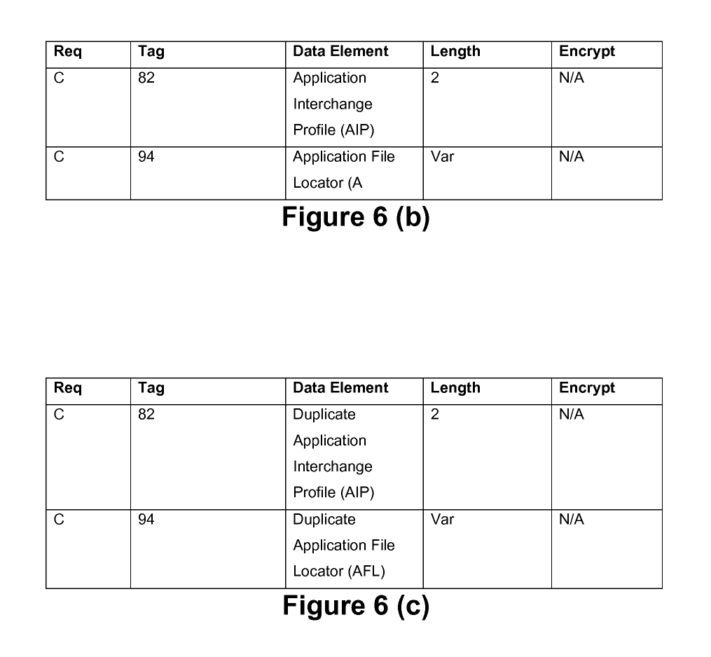

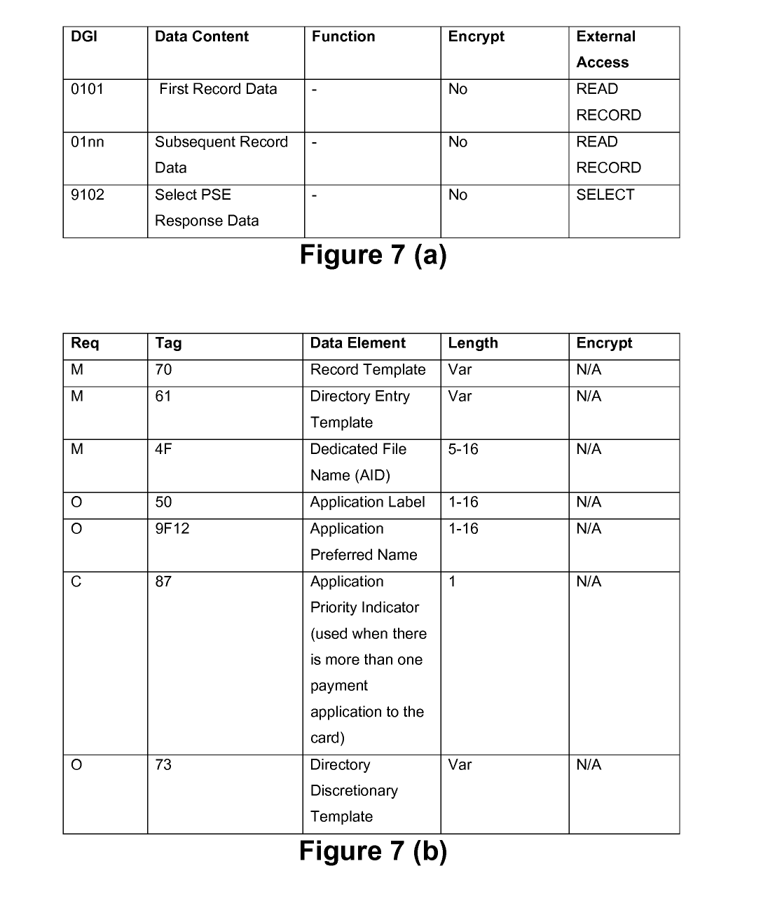

FIG. 5 shows a table of different parameter groups defined in the EMV standard. Each group is given a data grouping identifier (‘DGI’). Three groups of parameters are shown: 9102, 9104 and 91nn. FIG. 6(a) shows a table of the parameters contained within the DGI group ‘9102’. FIG. 6(b) shows a table of parameters contained within the DGI group ‘9104’. FIG. 6(c) shows a table of parameters contained within the DGI group ‘91nn’. The parameters in FIGS. 6(a) to 6(c) are examples of parameters which may be set to a default value in accordance with an embodiment.

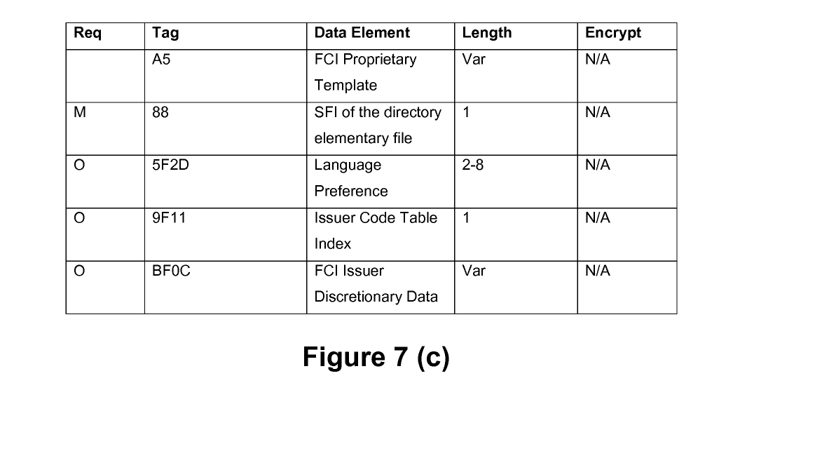

FIG. 7(a) shows a table of different parameter groups defined in the PSE standard. Each group is given a data grouping identifier (‘DGI’). Three groups of parameters are shown: 0101, 01nn and 9102. FIG. 7(b) shows a table of the parameters contained within the DGI groups ‘0101’ and ‘01nn’. FIG. 7(c) shows a table of parameters contained within the DGI group ‘9102’. The parameters in FIGS. 7(b) and 7(c) are examples of parameters which may be set to a default value in accordance with an embodiment.

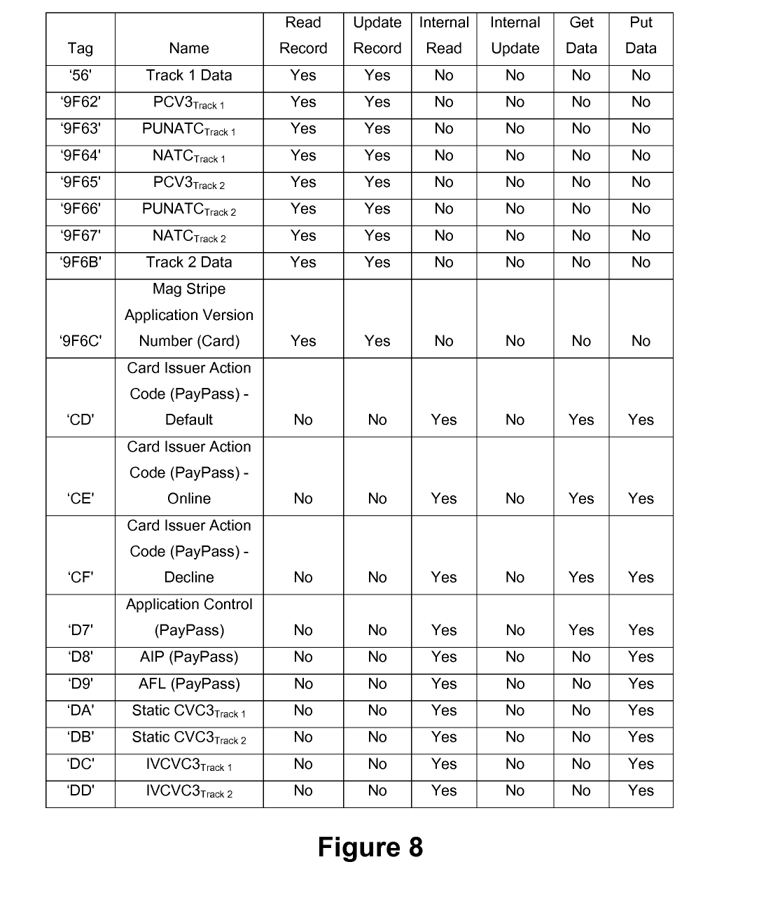

FIG. 8 shows a table of additional parameters which may be set to a default value in accordance with an embodiment. In an embodiment, setting at least some of the parameters of FIG. 8 to default values configured the payment chip to function in accordance with the MasterCard™ EMV PayPass™ protocol or another contactless payment protocol as would be known to the person skilled in the art. For example, these parameters may include Additional Persistent Data Objects from the EMV standard.

In an embodiment, at least some of the parameters set to default values are used to configure the payment chip for use in a particular geographical region, such as, for example, the Asia-Pacific region, Europe and/or Canada. Some examples of these parameters are: Card Issuer Action Code (Paypass™)—Default, Card Issuer Action Code (Paypass™)—Online, Card Issuer Action Code (PayPass™)—Decline, Application Control (Paypass™), Application Interchange Profile (AIP) (PayPass™) and Application File Locator (AFL) (PayPass™). AIP specifies the application functions that are supported by the card application. AFL specifies the list of files and related records for the currently selected application that shall be read by the terminal application for the subsequent transaction processing. In an embodiment, a manufacturer may configure all functions associated with a particular region within which a payment card in intended to operate. Accordingly, the issuer may simply configure functions relating to the specific customer who will be using the payment card.

It is to be understood that the example parameters of FIGS. 6(a)-(c), 7(b)-(c) and 8 are non-limiting. In an embodiment, all these parameters may be set to default values to configure multiple functions of the payment chip. In another embodiment, only some of these parameters may be set to a default value such that fewer functions of the payment chip are configured. In an embodiment, one or more parameters other than these parameters may be set to a default value to configure one or more functions of the payment card.

In an embodiment, a manufacturer may set parameters to default values such that all functions of the payment chip are configured. An advantage of this is that an issuer does not need to concern themselves with the technical process of configuring or electronically personalizing a payment chip. Such embodiments may be useful in generating prepaid payment cards.

In an embodiment, a manufacturer may set parameters to default values such that only some (but not all) functions of the payment chip are configured. An advantage of this is that an issuer is required to do less technical work compared to a situation where they have to complete all electrical personalization. Additionally, certain generic functions may be configured by the manufacturer, whereas certain specific functions may be configured by the issuer. For example, the generic functions may include: communicating data in accordance with the EMV standard and/or the PSE standard, or making a payment in accordance with the EMV standard and/or the PSE standard. The specific functions may include: making a payment from a specific bank account held by the issuer, or making a payment from a specific bank account of specific customer of the issuer. Such embodiments may be useful in generating bespoke payment cards, i.e. payment cards for a specific issuer and/or customer.

Electrical personalization can be a complex technical process and can require the preparation of correct data for loading onto a payment chip or card. In some instances, an issuer may not have the technical expertise to set parameters correctly since it is a financial institution, not an electronics company. Incorrectly setting parameters can result in the payment card malfunctioning during use or not working at all. On the other hand, the manufacturer maybe an electronics company since it is capable of manufacturing electronic devices, such as, payment chips. Therefore, moving at least a portion of the electrical personalization process from the issuer to the manufacturer can reduce the probability that payment chips will be configured incorrectly and malfunction or break.

It will be appreciated by a person skilled in the art that numerous variations and/or modifications may be made to the present invention as shown in the specific embodiments without departing from the scope of the appended claims as broadly described. The present embodiments are, therefore, to be considered in all respects to be illustrative and not restrictive.

1. A method for electrically personalizing a payment chip, the method comprising:
a. storing software onto the payment chip, the software comprising one or more parameters, the one or more parameters being configurable to define functions of the payment chip; and
b. setting at least one parameter to a default value to configure at least one function of the payment chip to electrically personalize the payment chip,
wherein step a. is performed by at least one entity and step b. is performed by the same at least one entity.

2. The method according to claim 1, further comprising storing data onto the payment chip by the at least one entity, the data being used by the payment chip to perform the configured at least one function.

3. The method according to claim 1, wherein the data comprises at least one of the following: application data, issuer data, customer data, an application encryption key, an issuer related encryption key, an encryption certificate.

4. The method according to claim 1, wherein the at least one function configures the payment chip to be able to communicate in accordance with the Europay, MasterCard and Visa (EMV) standard.

5. The method according to claim 4, wherein the at least one function configures the payment chip to be able to make a payment in accordance with the EMV standard.

6. The method according to claim 5, wherein the at least one function configures the payment chip to be able to make the payment from an account associated with a specific issuer.

7. The method according to claim 5, wherein the at least one function configures the payment chip to be able to make the payment from an account associated with a specific customer.

8. The method according to claim 1, wherein the software comprises an operating system.

9. The method according to claim 1, wherein the software comprises at least one application program comprising the one or more parameters.

10. The method according to claim 1, wherein the method further comprises, before step a., manufacturing the payment chip by the at least one entity.

11. The method according to claim 1, wherein the method further comprises attaching the payment chip to a carrier by the at least one entity.

12. The method according to claim 1, wherein the carrier is at least one of the following: a plastic card, a computing device.

13. The method according to claim 1, further comprising:
c. setting the at least one parameter from the default value to a custom value to re-configure the at least one function of the payment chip.

14. The method according to claim 13, wherein step c. is performed by the at least one entity.

15. The method according to claim 1, wherein the at least one entity is a manufacturer of the payment chip.

16. A payment chip having stored thereon software comprising one or more parameters, the one or more parameters being configurable to define functions of the payment chip, wherein at least one parameter is set to a default value to configure at least one function of the payment chip.

17. The payment chip of claim 16, having stored thereon data, wherein the payment chip is capable in use of using the data to perform the configured at least one function.
